(19) United States
(12) Patent Application Publication
(10) Pub. No.: US 2010/0035468 A1
(43) Pub. Date: Feb. 11, 2010

(54) COMMON INTEGRATED CIRCUIT FOR MULTIPLE ANTENNAS AND METHODS

(75) Inventors: Serge Perrot, Tullins (FR); Patrice Rigoland, Hamden, CT (US)

Correspondence Address: KLARQUIST SPARKMAN, LLP, 121 SW SALMON STREET, SUITE 1600, PORTLAND, OR, 97204, US

(73) Assignee: RADIALL INCORPORATED dba RADIALL ANTENNA TECHNOLOGY, Vancouver, WA (US)

(21) Appl. No.: 11/922,035

(22) PCT Filed: May 24, 2006
(86) PCT No.: PCT/US2006/020455

§ 371 Date: Oct. 19, 2009

Related U.S. Application Data
(60) Provisional application No. 60/684,491, filed on May 24, 2005.

(51) Int. Cl. H01R 13/648; H01Q 1/52

(52) U.S. Cl. 439/607.01; 343/841; 29/428

(57) ABSTRACT

In an active antenna system, two or more amplification chains are contained on one integrated circuit substrate or in one hybrid circuit. The amplification chains can be connected to at least one of a plurality of radiating elements. The integrated circuit or hybrid circuit can be incorporated into an active antenna connector, which can be electrically connected to a radiating element or a receiver system, for example. A first integrated circuit or hybrid circuit can be exchanged with a second integrated circuit or hybrid circuit in a connector to adjust properties of an active antenna system.

### CROSS REFERENCE TO RELATED APPLICATION

This application claims the benefit of U.S. Provisional Application No. 60/684,491, entitled “Common Integrated Circuit for Multiple Antennas and Methods,” filed May 24, 2005, which is incorporated herein by reference.

### FIELD

The disclosure pertains to integrated circuits for RF antenna systems.

### BACKGROUND

Active antennas are often used in RF transmission systems. FIG. 1 shows an example of a typical prior art active antenna system 100. The system comprises a radiating element 110, amplification stages 120, 130, and a band-pass filter 140. Multi-band antenna systems can require duplicating the architecture of system 100 for multiple bands. For example, a multi-band system (which can have one antenna or several antennas) configured to receive both GPS and SDARS signals can require one version of system 100 for GPS and an additional version of system 100 for SDARS.

### SUMMARY

Disclosed below are representative embodiments that are not intended to be limiting in any way. Instead, the present disclosure is directed toward novel and nonobvious features, aspects, and equivalents of the embodiments described below. The disclosed features and aspects of the embodiments can be used alone or in various novel and nonobvious combinations and sub-combinations with one another.

In one embodiment, an active antenna system comprises a plurality of antennas and a plurality of amplification chains, each chain connected to at least one of the plurality of antennas. The amplification chains occupy a single integrated circuit, and the chains comprise a low-noise amplifier (LNA) and a filter. The substrate comprises shielding to reduce crosstalk among amplification chains on the substrate. In one embodiment the system has no shielding external to the integrated circuit. In another embodiment, the integrated circuit is contained at least partly in a housing, and the housing provides electromagnetic shielding for the integrated circuit from electromagnetic radiation external to the housing. In another embodiment, the integrated circuit is physically separated from at least one of the plurality of antennas by a cable.

In a different embodiment, a connector comprises a housing, wherein the housing comprises a coaxial connector, and a circuit, wherein the circuit comprises at least two amplification chains, wherein the circuit is contained at least partly in the housing, and wherein the housing provides electromagnetic shielding for the circuit from electromagnetic radiation external to the housing. In one embodiment, the connector is physically connected to a radiating element. In another embodiment, the circuit comprises a hybrid circuit. In another embodiment, the circuit comprises an integrated circuit. In a further embodiment, the connector is physically connected to a first section of coaxial cable and a second section of coaxial cable, and the circuit can further comprise an active low-noise amplifier. In another embodiment, the connector is physically connected to a receiver system input. In another embodiment, the integrated circuit is a first integrated circuit configured for at least a first frequency range, the housing being configured such that the first integrated circuit can be replaced with a second integrated circuit configured for at least a second frequency range.

In another embodiment, a method of installing an active antenna system at an installation surface comprises attaching a plurality of antennas to the installation surface, placing a component housing in electrical communication with the plurality of antennas, and placing a circuit component at least partly in the component housing, wherein the circuit component comprises at least two amplification chains. In a further embodiment, the housing can provide electromagnetic shielding for the circuit component from electromagnetic radiation external to the housing. In one embodiment, the circuit component comprises an integrated circuit. In another embodiment, the circuit component comprises a hybrid circuit.

In an additional embodiment, a method of upgrading an active antenna system, where the system comprises at least one antenna, a connector housing, and a first integrated circuit comprising at least one amplification chain, wherein the integrated circuit is contained at least partly in the housing, the method comprises installing at least one additional antenna, replacing the first integrated circuit contained at least partly in the housing with a second integrated circuit contained at least partly in the housing, wherein the second integrated circuit comprises at least two amplification chains, and placing the second integrated circuit in electrical communication with the at least one antenna and the at least one additional antenna.

The foregoing and other objects, features, and advantages of the invention will become more apparent from the following detailed description, which proceeds with reference to the accompanying figures.

### BRIEF DESCRIPTION OF THE DRAWINGS

FIG. 1 shows a block diagram of a prior art active antenna system.

FIG. 2 depicts an exemplary satellite- and terrestrial-based transmission system.

FIG. 3 depicts a block diagram of one embodiment of a multi-band antenna system employing an integrated circuit.

FIG. 4 shows a side view of one embodiment of an active antenna connector.

FIG. 5 shows a side cut-away view of the connector shown in FIG. 4.

FIG. 6 is a right-end view of the connector shown in FIG. 4.

FIG. 7 depicts a block diagram of one embodiment of a multi-band antenna system employing hybrid circuit.

### DETAILED DESCRIPTION

FIG. 2 depicts an exemplary satellite- and terrestrial-based transmission system 200. The system comprises one or more satellites 230, one or more terrestrial antennas 240, and an antenna location, such as vehicle 210, comprising one or more antennas 220. Examples of satellite-based transmission systems include GPS, SDARS, Ku Band, and Ka Band. Examples of terrestrial-based systems include AM/FM, AMPS/Digital Cellular, PCS, SDARS Repeaters, Bluetooth, WLAN, DAB, DVBT, and DSRC. Those of skill in the art will recognize other possible systems that can be used with the technologies described herein. Antennas 220 can be configured to receive and/or transmit signals for one or more transmission systems.

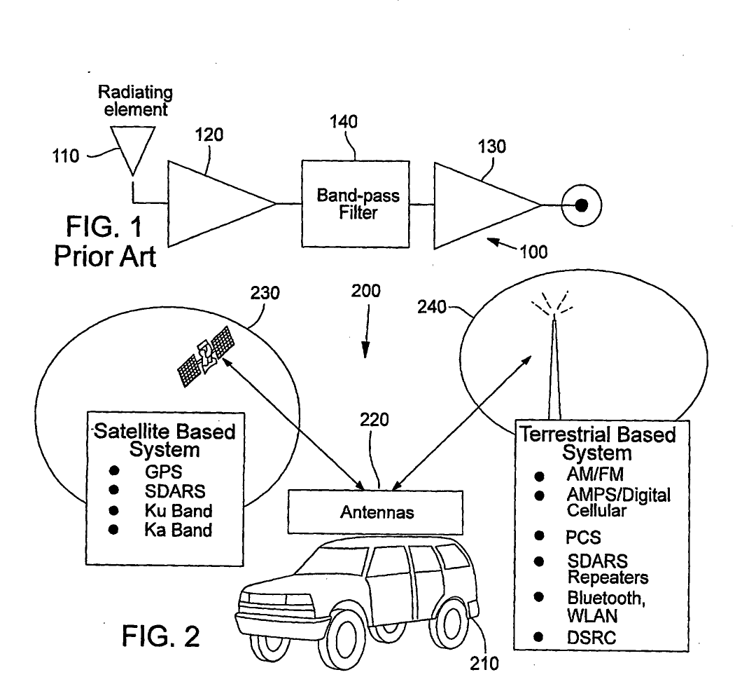

As explained above, implementing multiple receiving antennas can require implementation of several amplification chains such as those shown in FIG. 1. Some possible implementations include a system comprising a broadband amplifier stage, or a system comprising multiple, singe-band radiating elements. However, performance in such systems generally suffers from a poor SNR and a lack of isolation among frequencies. Implementing multiple amplification chains in hybrid circuits can produce systems with a larger physical form factor than desired.

### Exemplary Integrated Circuit Embodiments

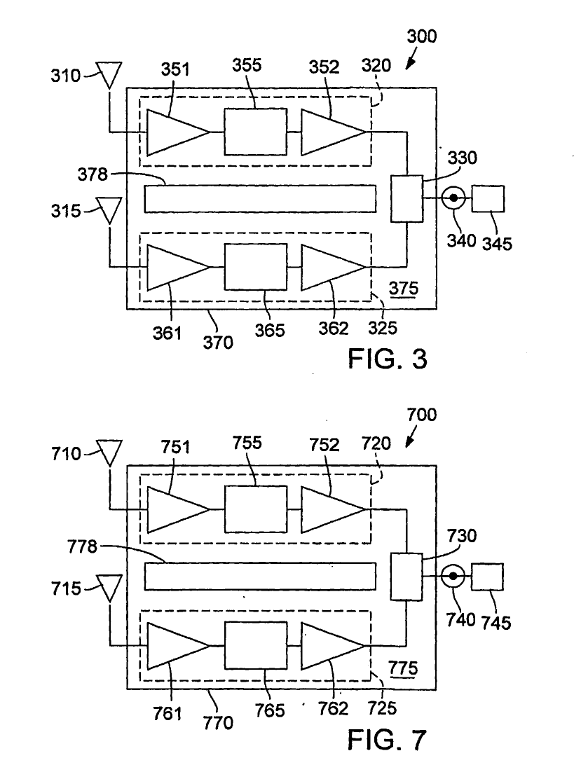

FIG. 3 depicts a block diagram of one embodiment of a multi-band antenna system 300 employing an integrated circuit 370. The integrated circuit 370 is also referred to herein as an “active module chipset.” The system comprises radiating elements (e.g., antennas) 310, 315, amplification chains 320, 325, possibly a multiplexer 330, and an output 340. Output 340 can be electrically connected with a receiving system 345. Amplification chain 320 comprises low-noise amplifiers 351, 352 and a filter (usually a band-pass filter) 355. Amplification chain 325 comprises low-noise amplifiers 361, 362 and a filter (usually a band-pass filter) 365. Other embodiments can comprise additional amplification chains. Amplification chains 320, 325 (and, in some embodiments, multiplexer 330) are on a single integrated circuit substrate 375. The integrated circuit 370 can also comprise electromagnetic shielding 378 to reduce electromagnetic interference among the two or more amplification chains 320, 325. In one embodiment, the electromagnetic shielding 378 can render additional shielding outside integrated circuit 370 unnecessary. Components of integrated circuit 370 can be physically separated from radiating elements 310, 315 and output 340 by a cable, such as a coaxial cable.

Integrated circuit 370 can allow for a more compact multi-band system. Due to the compact size, the amplification chains 320, 325 can be less sensitive to the layout of the system 300. This can provide the following advantages:
Reduced effect of the radiating element(s) on other elements of the design, thus allowing more flexible integration and less need (or no need) for additional shielding of the amplification chains.
More robust amplification chain elements (e.g., LNAs 351, 352, 361,362, filters 355, 365). Filters can be sensitive to the effects of integration. For filters like the ones discussed above, qualities like selectivity, center frequency and bandwidth can be more reliable with a monolithic integrated circuit package.
Reduced EMI and ESD sensitivity of the amplification chain. Early in the design process, both of these characteristics can be optimized.
Reduced parasitic effects (e.g., crosstalk) among the integrated amplification chains 320, 325. During the design process, undesired interactions between amplification chains can be minimized.
More efficient combination of the multiple outputs through direct integration of an RF multiplexer during the design process.

Additionally, design time can be reduced, in part because a less-intensive tolerance study for elements of the amplifier stage can be needed.

In terms of mechanical characteristics, reducing the number of elements to one integrated circuit substrate can offer advantages such as:
Reduced risk of failure due to vibration (which can be a chief mechanical constraint in automotive applications) and cracks in soldering joints. Integrating components can allow a circuit with fewer soldering joints. This characteristic can offer advantages in term of reliability of the connection during the process of soldering (SMT, or “surface mount technology”).
Reduced multi-band antenna package footprint. The reduction in size offered by this technology can allow the reduction in size of the antenna. A smaller antenna can make the assembly more resistant to environmental and mechanical constraint such as (wind load, pulse water (e.g., in a car wash), pull force, vibration, etc.).
Increased flexibility in terms of integration. A smaller package footprint can allow for more mounting options (e.g., it can easily fit a broad range of roof curvatures) and more antenna options.

The described technology can allow for a size reduction of approximately 20-50% in multiple amplification chains, with the percent-size-reduction increasing with the number of amplification chains integrated into the monolithic device.

From a manufacturing perspective, this technology can offer benefits in terms of:
Improved production processes: Using this component can offer increased flexibility for some aspects of manufacturing. For example, positioning RF cables associated with implementing a multi-band active antenna system would be greatly simplified due to the reduction in size of the active module. Additionally, the reduction in size can also aid integration of the amplification chains with other parts. For example, the chains can be implemented with an active antenna connector (described below).
Improved quality and facility controls: Automotive manufacturers often employ the PPM as a quality index when selecting components. The PPM represents the number of failures observed on 1 million parts. An integrated circuit solution can require integrating fewer parts in the assembly and can be a low tolerance technology. In addition, with present hybrid technology, testing the active stage is not possible before assembly of the product is complete. With an integrated circuit approach, a probe process (e.g., Pico probe type of test) can be used in order to improve the quality of the product before implementation by detecting any important defects.
Environmentally friendly products: The reduction of number of parts and the processes used in manufacturing the chipset can help the module meet environmental requirements (e.g., lead-free processes).
Decreased cost: The implementation of the integrated circuit approach can allow for cost savings in development (simplification of the design), material (miniaturization of the antenna package and reduction of the number of parts), assembly (increased ease of manufacture and integration) and quality (potential of low PPM).

### Exemplary Active Antenna Connector Applications

In one embodiment, the active module chipset can be configured within a connector, perhaps in one like the connector shown in PCT Patent Application Serial No. PCT/US2005/019680, which is incorporated herein by reference.

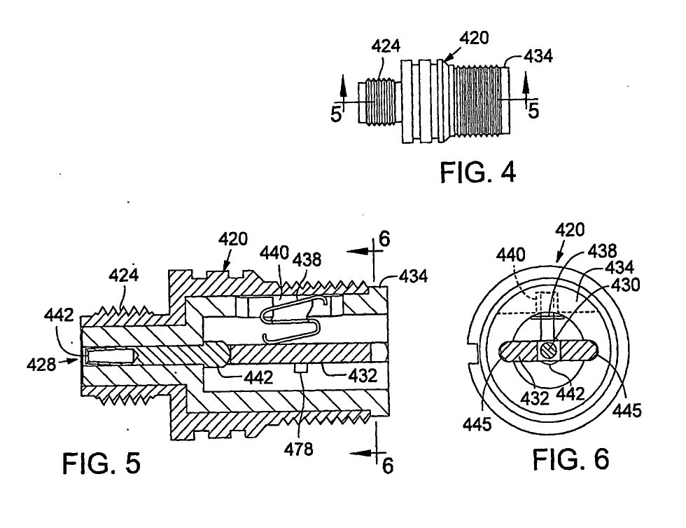

FIG. 4 shows a side view of one embodiment of a connector 400. Connector 400 comprises a connector body 420, featuring a threaded first end 424, and an insulator insert 434, at least part of which fits inside connector body 420.

FIG. 5 shows a side cut away view of connector 400, taken along 5-5 in FIG. 4. FIG. 5 shows an opening 440 in the side of the insulator insert 434 allowing an electrical connection between a side of a circuit component 432 and the connector body 420, which can be ground via a spring contact 438. The spring contact 438 can also exert a biasing force against the circuit component 432 to assist in holding it in place. Circuit component 432 can be electrically connected to a socket-type contact 442. In the illustrated embodiment, a device interface 428 is defined at the threaded first end 424 for establishing an electrical connection between connector 400 and a first device (not shown), either directly or via a cable extending to or from that device. The first device can be, for example, a radiating element or a receiver system.

FIG. 6 is a right-end view showing the circuit component 432 in place, with its side edges received in grooves 445 formed in the insulator insert 434. An inner contact 430 can establish electrical contact with circuit component 432 and a second device (not shown). The second device can be, for example, a radiating element or a receiver system.

Returning to FIG. 5, circuit component 432 comprises an electronic component 478. In one embodiment, electronic component 478 comprises an integrated circuit or active module chipset, as described above. In another embodiment, electronic component 478 comprises a hybrid circuit. FIG. 7 depicts a block diagram of one embodiment of a multi-band antenna system 700 employing a hybrid circuit 770. The system 700 comprises radiating elements (e.g., antennas) 710, 715, amplification chains 720, 725, a multiplexer 730, and an output 740, which can be electrically connected with a receiving system 745. Amplification chain 720 comprises low-noise amplifiers 751, 752 and a filter (usually a band-pass filter) 755. Amplification chain 725 comprises low-noise amplifiers 761, 762 and a filter (usually a band-pass filter) 765. Other embodiments can comprise additional amplification chains. Amplification chains 720, 725 (and, in some embodiments, multiplexer 730) are on a substrate 775, such as a circuit board or other hybrid circuit substrate, as is well known in the art. Components of amplification chains 720, 725 can be several discrete parts. The substrate 775 can also comprise electromagnetic shielding 778 to reduce electromagnetic interference among the two or more amplification chains 720, 725. Some or all of substrate 775 and the components it features can be packaged in one or several of the many hybrid circuit coverings known in the art (not shown). Components of hybrid circuit 770 can be physically separated from radiating elements 710, 715 and output 740 by a cable, such as a coaxial cable.

The body of a connector can be modified in order to accommodate different configurations of a chipset or hybrid circuit. A connector featuring an active module chipset or hybrid circuit, such as those described above, can offer advantages such as:
Flexible frequency response: By changing the connector, a radiating element can be matched at different frequencies as needed for a given application, including when an active antenna system is installed. For AM/FM, for example, one antenna can be matched with one configuration at a frequency commonly used in Europe, and by changing the active module chipset (or hybrid circuit) be matched at a frequency commonly used in the US.
Multi-purpose construction: By swapping a first chipset with a second chipset, one antenna can be matched for a number of applications, upgraded from one application to another, or upgraded to include additional applications (e.g., additional radiating elements and/or amplification chains can be added). For example, configurations can be created to provide AM/FM only or AM/FM and DAB, or AM/FM and/or DAB and/or DVBT.
Integration-friendly construction: The connector can be integrated at different levels in the chain (e.g., in the radiating element, at various positions in a coaxial lead, at an input of a receiver) as desired for a particular system.

### Applications

The technologies described herein are generally applicable to mobile objects such as, but not limited to, automobiles, ships, airplanes, helicopters, military vehicles, etc. Aviation and/or railway applications can include GPS, telemetry and infotainment (e.g., satellite TV and radio). Military applications can include GPS L1/L2, GALILEO and IMMARSAT. In one embodiment, a person can carry on his or her person one or more radiating elements that are in communication with a circuit comprising multiple antenna chains. For example, the radiating elements can be mounted on his or her shoulder, and a wire can carry signals between the radiating elements and the circuit mounted in a backpack, belt, or other piece of clothing. Such a configuration can be useful in a situation where a mobile person needs to have some degree of radio communication, e.g., a soldier on a battlefield.

In other embodiments, the technology is applied to stationary platforms such as buildings.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. An active antenna system, comprising:
a plurality of antennas; and
a plurality of amplification chains each connected to at least one of the plurality of antennas;
wherein at least two of the amplification chains occupy a single integrated circuit;
wherein an amplification chain comprises:
a low-noise amplifier (LNA); and
a filter; and
wherein the substrate comprises shielding to reduce crosstalk among amplification chains on the substrate.

2. The active antenna system of claim 1, wherein the integrated circuit is contained at least partly in a housing, and wherein the housing provides electromagnetic shielding for the integrated circuit from electromagnetic radiation external to the housing.

3. The active antenna system of claim 1, wherein the system has no shielding external to the integrated circuit.

4. The active antenna system of claim 1, wherein the integrated circuit is physically separated from at least one of the plurality of antennas by a cable.

5. A connector, comprising:
a housing, wherein the housing comprises a coaxial connector;
a circuit, wherein the circuit comprises at least two amplification chains, wherein the circuit is contained at least partly in the housing, and wherein the housing provides electromagnetic shielding for the circuit from electromagnetic radiation external to the housing.

6. The connector of claim 5, wherein the connector is physically connected to a radiating element.

7. The connector of claim 5, wherein the circuit comprises a hybrid circuit.

8. The connector of claim 5, wherein the circuit comprises an integrated circuit.

9. The connector of claim 5, wherein the connector is physically connected to a first section of coaxial cable and a second section of coaxial cable.

10. The connector of claim 9, wherein the circuit further comprises an active low-noise amplifier.

11. The connector of claim 5, wherein the connector is physically connected to a receiver system input.

12. The connector of claim 5, wherein the integrated circuit is a first integrated circuit configured for at least a first frequency range, the housing being configured such that the first integrated circuit can be replaced with a second integrated circuit configured for at least a second frequency range.

13. A method of installing an active antenna system at an installation surface, the method comprising:
attaching a plurality of antennas to the installation surface;
placing a component housing in electrical communication with the plurality of antennas; and
placing a circuit component at least partly in the component housing, wherein the circuit component comprises at least two amplification chains.

14. The method of claim 13, wherein the housing provides electromagnetic shielding for the circuit component from electromagnetic radiation external to the housing.

15. The method of claim 13, wherein the circuit component comprises an integrated circuit.

16. The method of claim 13, wherein the circuit component comprises a hybrid circuit.

17. A method of upgrading an active antenna system, the system comprising at least one antenna, a connector housing, and a first integrated circuit comprising at least one amplification chain, wherein the integrated circuit is contained at least partly in the housing, the method comprising:
installing at least one additional antenna;
replacing the first integrated circuit contained at least partly in the housing with a second integrated circuit contained at least partly in the housing, wherein the second integrated circuit comprises at least two amplification chains; and
placing the second integrated circuit in electrical communication with the at least one antenna and the at least one additional antenna.
